(19) United States
(12) Patent Application Publication
(10) Pub. No.: US 2011/0008601 A1
(43) Pub. Date: Jan. 13, 2011

(54) FLEXIBLE CEMENT PANEL AND METHOD OF MANUFACTURING SAME

(75) Inventor: Bret K. Reimann, West Valley City, UT (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: Stone Passion, L.L.C., Salt Lake City, UT

(21) Appl. No.: 12/498,938

(22) Filed: Jul. 7, 2009

(51) Int. Cl. B32B 13/12; B05D 3/00

(52) U.S. Cl. 428/220; 427/209

(57) ABSTRACT

Flexible panels and methods for manufacturing the same are disclosed. In some embodiments, epoxy resin is applied to one or more surfaces of a hardened cement structure and impregnates the structure. The epoxy resin can cure and can provide the cement structure with flexibility and resilience. In some embodiments, the cement panels can flex by a visible amount substantially without cracking or breaking.

### TECHNICAL FIELD

Certain embodiments described herein relate generally to the field of cement products, and relate more particularly to the field of cement coverings.

### BRIEF DESCRIPTION OF THE DRAWINGS

Non-limiting and non-exhaustive embodiments of the disclosure are described, including various embodiments depicted in the figures, in which:

FIG. 1 is a partially cut-away cross-sectional view of an embodiment of a wet cement mixture within an embodiment of a mold.

FIG. 2 is a partially cut-away cross-sectional view such as that of FIG. 1 showing application of epoxy to a first face of a substantially dry cement structure.

FIG. 3 is a partially cut-away cross-sectional view such as that of FIG. 2 showing the cement structure removed from the mold and application of epoxy to a second face of the cement structure.

FIG. 4 is a partially cut-away cross-sectional view such as that of FIG. 3 showing two layers of epoxy that extend into the cement structure.

FIG. 5 is a partially cut-away perspective view of an embodiment of a flexible cement panel that defines a length L and a thickness T.

### DETAILED DESCRIPTION

The use of cement is well-known in a wide variety of construction applications such as, for example, in concrete that is prepared and/or laid on-site for building foundations, sidewalks, highways, runways, and bridge decks. Cement can also be used in pre-cast products that are prepared off-site and transported to a construction site. Such pre-cast cement products can include some form of structurally supportive backing to prevent the cement from cracking or breaking during transport, installation, and/or use.

Known cement products can suffer from a variety of drawbacks and limitations. For example, pre-cast cement products can be relatively heavy, and thus difficult to handle during installation. Additionally, use of structurally supportive backing can add steps and material costs to the manufacturing process of the pre-fabricated products. Further, pre-cast cement products can be relatively rigid or inflexible and thus will crack or break, rather than bend in a resilient manner, when force sufficient to deform such a product is applied to the product.

Certain embodiments described herein may address one or more of the foregoing problems and limitations of known cement products. For example, in some embodiments, cement panels are provided that are relatively lightweight and thus relatively efficient and easy to transport and install. In some embodiments, the panels are sufficiently thin and flexible to be deformed without cracking or breaking. The panels do not necessarily require the use of supportive backing material, which can facilitate flexing of the panels and installation of the panels, and can reduce manufacturing costs.

In some embodiments, the panels are relatively thin, which may lead to a lightweight construction well-suited to mounting the panels to surfaces of various orientations (e.g., vertical, horizontal, etc.). Some panels can be sufficiently thin to cover existing surfaces without significantly reducing available space or adding significant bulk to the covered surface. In some embodiments, the panels are configured to cover existing surfaces and can be easily installed without first removing a surface covering that is to be replaced. For example, certain panels that can be used as surfacing for a shower may be installed over existing tile without significantly reducing the maneuverable space within the shower.

In further embodiments, the panels are decoratively colored and can be used in a wide variety of aesthetic applications. For example, in some instances the panels can be used as decorative finishing materials for flooring, shower and tub surrounds, inlays in furniture and cabinets, wall paneling, and recreational vehicle paneling. The panels can advantageously be installed directly on sub-flooring and can flex therewith. Additional uses and advantages of various embodiments will be apparent from the disclosure herein.

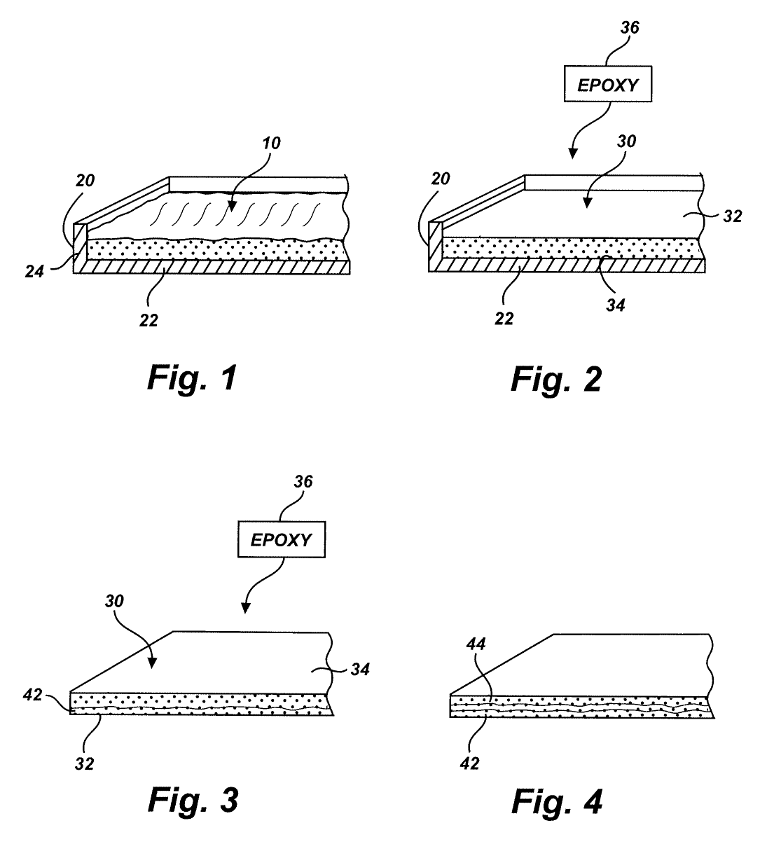

With reference to FIG. 1, in certain embodiments, a method of manufacturing a flexible cement panel includes combining dry cement and a liquid (e.g., water) to form a wet cement mixture 10. The dry cement can comprise any of a variety of cements, such as, for example, Portland cement (including types I, II, III and V), Riverside white cement, or any cement that is in compliance with the Portland Cement Association. In some arrangements, the cement can be a non-hydraulic cement, and thus can be relatively less dense and/or relatively more porous than hydraulic cements.

The dry cement and liquid can be mixed in any suitable manner to provide a wet cement mixture 10, which in some preferred arrangements is relatively porous. For example, the dry cement and liquid can be mixed and agitated by a wide variety of mixers which would be apparent to those having skill in the art aided by the present disclosure. For example, a concrete mix may be mixed for approximately three to five minutes to produce a well distributed mixture. Additives, such as water-reducers may be used to maintain a uniform water ratio having both the proper hydration for strength and plasticity for ease of work.

In some arrangements, epoxy is not added to the wet cement mixture. Rather, as discussed below, epoxy is added to the cement mixture once it is dry or substantially dry. In some embodiments, delaying addition of epoxy to the cement in such a manner can provide a finished panel having a more aesthetically appealing appearance. For example, as compared with certain panels for which epoxy is added to the wet cement mixture 10, some panels for which epoxy is withheld from the wet cement mixture 10 and applied after the cement mixture is substantially dry have an appearance of a relatively greater depth of material, i.e., three dimensional look of the surface. In other embodiments, epoxy can be added to the wet cement mixture 10.

In certain embodiments, a form or mold 20 is provided. The mold 20 can define any desired shape, such as a partial rectangular box. The mold 20 can include a base wall 22 and one or more side walls 24. The wet cement mixture 10 can be added to the mold 20 and flattened or spread relative to the base wall 22, and may extend to the side walls 24. Any suitable method may be used to spread the wet cement mixture 10. For example, in some embodiments, the wet cement mixture 10 is troweled by hand or machine to provide the wet cement mixture 10 with a substantially smooth and substantially planar surface.

In other embodiments, a removable cover (not shown) can form a temporary top surface of the mold 20, and the wet cement mixture 10 can be injected into the mold 20 to fill or substantially fill a space between the removable to cover and the base wall 22. As the wet cement mixture 10 fills the mold 20, the cement mixture can contact the removable top cover such that the wet cement mixture 10 is flattened relative to the base wall 22. The wet cement mixture 10 can spread (e.g., spread out) within the mold 20 as additional cement mixture is added to the mold 20. In some embodiments, the top cover is removed from the mold 20 after the wet cement mixture 10 has filled or substantially filled the space defined by the mold 20 and the top cover, which can aid in drying the wet cement mixture 10.

Other suitable methods of filling the mold 20 with the wet cement mixture 10 and/or flattening or spreading the wet cement mixture 10 relative to the mold 20 are also possible. For example, in some embodiments, one or more constituent components of the wet cement mixture 10 are separately added to the mold 20, mixed within the mold 20, and the resulting wet cement mixture 10 is then flattened or spread within the mold 20.

The mold 20 can be substantially void of structurally supportive backing to which the wet cement mixture 10 can attach when drying. The term “structurally supportive backing” is meant to describe the varieties of backings that are typically applied to pre-cast cement products to provide support to the cement once it has dried. For example, term “structurally supportive backings” can include metal, plastic, cloth, or fiberglass in the form of matting, woven material, threads, or short lengths of chopped fibers. Additionally, the term can include flexible and resilient backing layers, such as those used in certain cement tiles for buildings, and carrier layers, such as those used in fabricating linoleum. Other backings that can provide support or rigidity to a completed panel are also included in this term. Although the base wall 22 of the mold 20 may provide support to the wet cement mixture 10 as the mixture dries and hardens, the base wall 22 is not considered to be a structurally supportive backing because it does not ultimately remain with a finished cement panel.

With reference to FIG. 2, in certain embodiments, the wet cement mixture 10 is permitted and/or encouraged to dry within the mold 20. The wet cement mixture 10 thus can harden into a substantially dry and/or substantially hardened cement structure 30, which can define a first face 32 and a second face 34. In various embodiments, the first face 32 and the second face 34 define a thickness of the cement structure 30 that is between about ⅛ inch and about ½ inch, between about 3/16 inch and about ¼ inch, no more than about ⅛ inch, no more than about 3/16 inch, no more than about ¼ inch, no more than about 5/16 inch, no more than about ⅜ inch, or no more than about ½ inch.

In certain embodiments, a dry or substantially dry cement structure 30 can comprise relatively less liquid than the wet cement mixture 10, and in further instances, can comprise little to no liquid. A hardened or substantially hardened cement mixture can be more rigid than the wet cement mixture 10, and in further instances, can be stiff and substantially inflexible, and may in some arrangements be brittle. In certain embodiments, the cement structure 30 can crack or break upon removal of at least a portion of the mold 20. For example, in some embodiments, removal of the base wall 22 of the mold 20 when the first face 32 of the cement structure 30 is oriented substantially orthogonally with respect to the direction of gravitational force would cause the cement structure 30 to crack and/or break under its own weight. Similarly, in some embodiments, the cement structure 30 can crack and/or break under a modest human-imparted force. As used herein, the term “human-imparted force” means a force that a human is capable of delivering without use of a machine or other instrument. For example, a human-imparted force can consist of the force generated by a human when contacting a central portion of the cement structure 30 to the human's knee and using each hand to pull on an opposing edge of the cement structure 30 toward the human's core.

As mentioned above, in some embodiments, the mold is void of structurally supportive backings when the wet cement mixture 10 is applied to the mold 20. Accordingly, the cement structure 30 can be free from contact with a structurally supportive backing. For example, neither the first face 32 nor the second face 34 is in contact with a structurally supportive backing in the illustrated embodiment.

In certain embodiments, a resin or other suitable coating material is applied to the first face 32 of the cement structure 30. In the illustrated embodiment, an epoxy resin 36 is used. By way of example, an epoxy composition sold under the trademark PERAN STC may be used, which is an isophorone diamine solution. Alternative epoxy resins 36 may include siloxane-based resins, such as those sold under the trademark PSX 700, and/or aliphatic polyisocyanates, such as those sold under the trademark AQUATHANE. Other alternative epoxy resins that may be used are those sold under the trademarks PROTOP 1000, DEVOE, IMRON and the like.

The resin can be applied without removing the structure 30 from the mold 20. In certain embodiments, a quantity of resin is spread over or otherwise applied to the first face 32 in sufficient amount to impregnate at least a portion of the cement structure 30. In some embodiments, the first face 32 of the cement structure 30 is oriented upward, or above the second face 34, as the resin is applied such that the resin can move downward through the cement structure 30 toward the second face 34. Some or all of the resin applied may impregnate the cement structure 30.

In one embodiment, approximately 100% epoxy solids are diluted about 25% and the mixture is poured and spread over the cement structure 30. The cement structure may still remain in the mold to allow for saturation of the epoxy resin 36. Pressure may be applied during the application of epoxy, and/or preheating either the epoxy or the cement structure 30, or both. The cement structure 30 can be cured after application of the epoxy resin 36. After curing the panel may be sanded and one or more spray coats of additional resin, such as PSX 700 or the like may be applied.

In certain embodiments, resin that has impregnated the cement structure 30 via the first face 32 is permitted or encouraged to cure, such as through the application of heat and/or the movement of air across the surface of the resin- impregnated panel. In some embodiments, the cured resin can strengthen the cement structure 30 and/or provide the cement structure with sufficient flexibility and resilience such that the structure can withstand removal of at least a portion of the mold 20 substantially without cracking or breaking.

With reference to FIG. 3, the cured resin can define a first resin layer 42 that extends from the first face 32 to an interior region of the cement structure 30. Some of or the entire mold 20 can be removed from the cement structure 30 to provide access to the second face 34. In some embodiments, only the base wall 22 is removed, while in other embodiments, the base wall 22 and the side walls 24 are removed.

A second quantity of resin (e.g., epoxy resin 36 in the illustrated embodiment) can be applied to the second face 34 of the cement structure 30. The second quantity of resin can comprise the same material as and/or a material different from the first quantity of resin. A sufficient amount of resin can be applied to the second face 34 to impregnate at least a portion of the cement structure 30. In some embodiments, the second face 34 of the cement structure 30 is oriented upward, or above the first face 32, as the resin is applied such that the resin can move downward through the structure 30 toward the first face 32. Some or all of the second quantity of resin applied may impregnate the cement structure 30.

With reference to FIG. 4, the portion of the second quantity of resin that impregnates the cement structure 30 can be permitted or encouraged to cure, and can thus form a second layer 44 of cured resin. As with the first resin layer 42, the second resin layer 44 can strengthen the cement structure 30 and/or provide the cement structure 30 with flexibility and resilience.

In some embodiments, the first resin layer 42 and the second resin layer 44 can be separate from each other, such that an interior portion of the cement structure 30 is substantially void of resin. In other embodiments, the first layer 42 and the second layer 44 meet or overlap such that substantially the entire cement structure 30 is impregnated with resin.

Other methods of impregnating the cement structure 30 with resin are also possible. In some embodiments, the cement structure 30 is immersed in a resin bath before and/or after removal of the mold 20. For example, in some embodiments, the cement structure 30 is submerged in resin while within the mold 20 until at least a portion of the cement structure 30 is impregnated with resin via the first face 32, and then the mold 20 is removed to expose the second face 34 to the resin.

After resin within the cement structure 30 has cured, the cement structure 30 can be milled, sanded, or otherwise processed to a desired final configuration. A decorative coating also can be applied to the panel. In further embodiments, an aliphatic coating is applied to the panel to prevent yellowing, fading, or other discoloration.

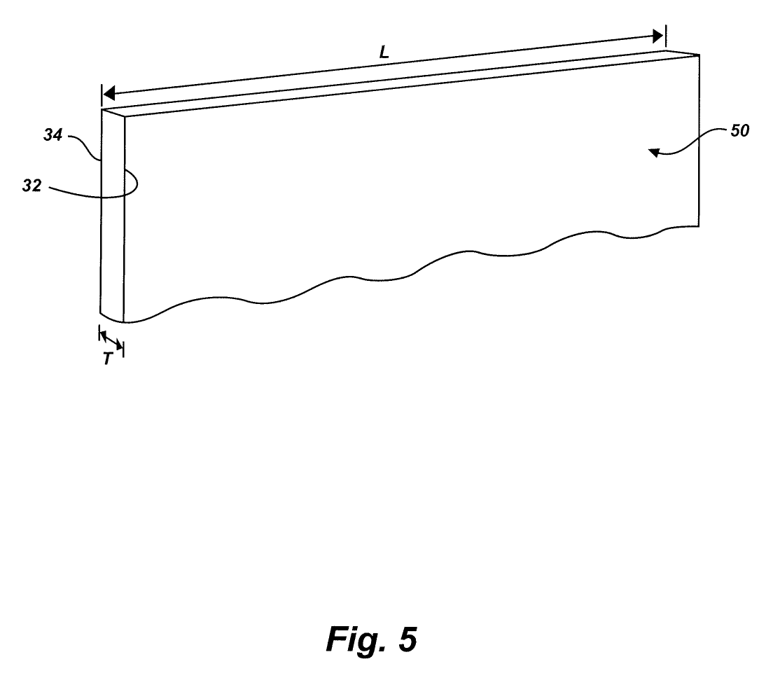

With reference to FIG. 5, in certain embodiments, a finished panel 50 can define a thickness T between the first face 32 and the second face 34 of the cement structure 30. The thickness T can be substantially smaller than a length L or a width (not shown) of the panel 50. In various embodiments, the ratio of thickness T to length L is no less than about 1:100, 1:200, 1:300, 1:400, 1:500 and 1:600. In some embodiments the length may range between about 72 to 120 inches and a width between about 36 to about 60 inches. Custom sizes may also be produced.

The panel 50 can desirably be flexible. For example, the panel 50 can be configured to transition between a natural state and a deformed state substantially without cracking or breaking. In the natural state, the panel 50 can be in a resting state or a natural configuration. In the deformed state, the panel 50 can be visibly bent or bowed. The term “visibly” is meant to connote that a condition is perceivable by the unaided human eye.

The panel 50 can be transitioned from the natural state to the deformed state by application of a force to the panel, such as a force applied in a direction substantially parallel to a line of thickness T of the panel. For example, a human-imparted force applied in a direction substantially perpendicular to a planar first face 32 can be sufficient to cause the panel 50 to visibly bow such that the first face 32 is curved. The amount of force used to transition the panel 50 from the natural state to the deformed state can be substantially less than the amount of force used to crack or break typical pre-cast cement products. The panel 50 can be sufficiently resilient to transition from the deformed state to the natural state upon removal of the force. The panel 50 may be beneficially applied to radius, wave or certain deformed walls. Furthermore, because of the relative light-weight nature of the panel 50, the time and cost of panel installation may be reduced compared to conventional methods.

In some embodiments, the panel 50 comprises one or more coloring agents that provide the panel 50 with aesthetic appeal. For example, the one or more coloring agents can render the panel 50 visually distinct from a like panel that does not include coloring agents. In some embodiments, the panel 50 resembles marble.

In various embodiments, the panel 50 can be used in non-load-bearing applications. For example, the panel 50 can be used as a wall panel. Because the panel 50 can be thin and lightweight, it can be positioned with much less support than can be required for typical pre-cast cement products. Panels 50 that are lightweight can be particularly advantageous for such applications as recreational vehicle paneling in which use of lightweight materials is preferred.

As discussed above, in certain embodiments, the panel 50 is manufactured without structurally supportive backings. However, if desired, such backings may be applied to the panel 50, such as during installation of the panel 50.

The specific example included herein is for illustrative purposes only and is not to be considered as limiting to this disclosure. The compositions referred to and used in the following examples are either commercially available or can be prepared according to standard literature procedures by those skilled in the art.

### EXAMPLE 1

A panel having dimensions of 4 feet by 8 feet by 3/16 inch was prepared as follows: A bath mold was obtained having the necessary dimensions of the finished panel product. A cement mixture was prepared and was applied to the mold. The cement was spread throughout the mold through a combination of trowels, screeds, rollers and the use of hands. The cement panel and mold were then moved into a curing stage, where the cement was allowed to air dry for approximately 24 hours. Moisture content of the cement panel was evaluated. An epoxy mixture was then applied to the cement panel while it was still in the mold. The panel was then allowed to air cure for approximately 24 hours; however, in another method the curing process was accelerated by preheating the epoxy and the concrete materials. The cured epoxy-cement panel was sanded to create a uniform thickness. The panel was removed from the mold and placed upside down, i.e., face up. The panel was then inspected for defects. The face side of the panel was sanded and prepared for finishing coats. A layer of epoxy was sprayed on the sanded surface. A texture spray creating an orange peel surface was then applied. The finished coats were then cured through accelerated methods via heat and air induction. A protective film was placed over the surface of the finished panel, and placed with other finished panels face to face and back to back for shipment and/or storage.

It will be obvious to those having skill in the art that many changes may be made to the details of the above-described embodiments without departing from the underlying principles of the invention. The scope of the present invention should, therefore, be determined only by the following claims.

1. A method of manufacturing a flexible cement panel, the method comprising:
providing a mold;
mixing cement with liquid to form a wet cement mixture that is substantially free of epoxy;
spreading the wet cement mixture relative to the mold;
drying the wet cement mixture within the mold such that the cement becomes a hardened cement structure having a first face and a second face, the first and second faces defining a thickness therebetween, neither the first face nor the second face being in contact with any layers of structurally supportive backing material;
applying a first quantity of epoxy resin to the first face of the structure, thereby impregnating the hardened cement structure with at least a portion of the first quantity of epoxy resin; and
applying a second quantity of epoxy resin to the second face of the cement structure, thereby impregnating the hardened cement structure with at least a portion of the second quantity of epoxy resin,
wherein the at least a portion of the first and second quantities of epoxy resin that impregnate the cement structure provide the cement structure with flexibility and resilience such that the completed cement panel is configured to transition from a natural state, in which the panel is in a natural configuration, to a deformed state, in which the panel is visibly curved as compared with the natural configuration, upon application of a force to the panel in a direction substantially perpendicular to the first face of the cement structure, the panel configured to transition from the natural state to the deformed state substantially without the cement structure cracking and configured to transition from the deformed state to the natural state upon removal of the force.

2. The method of claim 1, wherein the step of applying the first quantity of epoxy resin to the first face of the hardened cement structure is performed without removing the hardened cement structure from the mold.

3. The method of claim 1, wherein a human-imparted force is sufficient to transition the completed cement panel from the natural state to the deformed state.

4. The method of claim 1, further comprising removing at least a portion of the mold to expose at least a portion of the second face of the cement structure prior to applying the second quantity of epoxy resin to the second face of the cement structure.

5. The method of claim 4, further comprising curing the at least a portion of the first layer of epoxy resin once it has impregnated the hardened cement structure, thereby strengthening the structure to withstand removal of the at least a portion of the mold without the structure cracking.

6. The method of claim 1, wherein the first face of the cement structure is substantially directed upward when the first quantity of epoxy resin is applied and the second face of the cement structure is substantially directed upward when the second quantity of epoxy resin is applied.

7. The method of claim 1, wherein epoxy resin permeates substantially the entire completed flexible cement panel.

8. The method of claim 1, wherein the thickness defined by the first and second faces of the cement structure is no greater than between about ⅛ inch and about ½ inch.

9. The method of claim 1, further comprising applying an aliphatic coating to the cement structure after applying the first and second quantities of epoxy resin.

10. A flexible cement panel comprising:
a layer of hardened cement defining a first face and a second face, the first and second faces defining a thickness therebetween, each of the first and second faces being free from any structurally supportive backing; and
resin extending through at least a portion of the layer of hardened cement, the resin providing the layer of hardened cement with flexibility and resilience such that the panel is configured to transition from a natural state, in which the panel is in a natural configuration, to a deformed state, in which the panel is visibly bowed as compared with the natural configuration, upon application of a force to the panel in a direction substantially perpendicular to the first face of the cement structure, the panel configured to transition from the natural state to the deformed state substantially without the cement cracking and configured to transition from the deformed state to the natural state upon removal of the force.

11. The panel of claim 10, wherein a human-imparted force is sufficient to transition the panel from the natural state to the deformed state.

12. The panel of claim 10, wherein the layer of hardened cement comprises one or more coloring agents that provide the layer with a visually distinct appearance as compared with uncolored cement.

13. The panel of claim 10, wherein the resin extending through at least a portion of the layer of hardened cement comprises a first resin layer extending through the first face and a second resin layer extending through the second face.

14. The panel of claim 13, wherein the first and second resin layers overlap within the layer of hardened cement.

15. The panel of claim 10, wherein the first and second faces define a thickness of the layer of hardened cement that is between about ⅛ inch and about ½ inch.

16. The panel of claim 10, wherein the first and second faces define a thickness of the layer of hardened cement that is between about ⅛ inch and about ¼ inch.

17. The panel of claim 10, wherein the layer of hardened cement comprises Portland cement.

18. The panel of claim 10, further comprising an aliphatic coating.

19. A flexible cement panel comprising:
a layer of hardened cement defining a first face and a second face substantially opposite the first face, the layer comprising one or more coloring agents that provide the panel with a visually distinct appearance as compared with uncolored cement, the first and second faces defining a thickness therebetween of no more than about ½ inch, each of the first and second faces being free from any structurally supportive backing;
a first epoxy resin layer extending into the layer of hardened cement from the first face; and
a second epoxy resin layer extending into the layer of hardened cement from the second face,
wherein the first and second epoxy resin layers provide the layer of hardened cement with flexibility and resilience such that the panel is configured to transition from a natural state, in which the panel is in a natural configuration, to a deformed state, in which the panel is visibly bowed as compared with the natural configuration, upon application of a force to the panel in a direction substantially perpendicular to the first face of the cement structure, the panel configured to transition from the natural state to the deformed state substantially without the cement cracking and configured to transition from the deformed state to the natural state upon removal of the force.

20. The panel of claim 19, wherein the second epoxy resin layer overlaps the first epoxy resin layer at a position between the first and second faces of the layer of hardened cement.
